(19) United States
(12) Patent Application Publication
(10) Pub. No.: US 2002/0172116 A1
(43) Pub. Date: Nov. 21, 2002

(54) Distribution of content

(76) Inventors: Javier Francisco Aprea, Eindhoven (NL); Aweke Nagash Lemma, Eindhoven (NL); Arnoldus Werner Johannes Oomen, Eindhoven (NL); Leon Maria Van De Kerkhof, Eindhoven (NL); Menno Anne Treffers, Eindhoven (NL)

Correspondence Address: Corporate Patent Counsel, Philips Electronics North America Corporation, 580 White Plains Road, Tarrytown, NY, 10591, US

(21) Appl. No.: 10/130,595

(22) PCT Filed: Sep. 13, 2001
(86) PCT No.: PCT/EP01/10638

(30) Foreign Application Priority Data
Sep. 20, 2000 (EP) 00120587.1

(51) Int. Cl. G11B 7/00

(52) U.S. Cl. 369/53.21

(57) ABSTRACT

Distributing content is provided, wherein at least one spoiler is added to the content to obtain spoiled content, and the spoiled content is distributed. In an embodiment, the spoiled content complies with a current format as well as with a further format, in which further format the spoilers are removable. In a further embodiment, de-spoil information is provided indicating how to remove the spoiler from the spoiled content.

The invention relates to distribution of content.

U.S. Pat. No. 5,479,168 discloses an electronic method and apparatus for signal encoding and decoding to provide ultra low distortion reproduction of analog signals, while remaining compatible with industry standardized signal playback apparatus not incorporating the decoding features of this document, and wherein the system provides an interplay of gain, slew rate and wave synthesis operations to reduce signal distortions and improve apparent resolution, all under the control of concealed control codes for triggering appropriate decoding signal reconstruction compensation complementing the signal analysis made during encoding.

An object of the invention is to provide an advantageous way of distributing content. To this end, the invention provides a method and device for distributing content, a method and device for receiving spoiled content, a signal representing content, a signal representing de-spoil information, a signal representing a key, a tangible medium, a reproduction device, a computer program, and a signal carrying a computer program as defined in the independent claims. Advantageous embodiments are defined in the dependent claims.

According to a first aspect of the invention, in distributing content, at least one spoiler is added to the content to obtain spoiled content, and the spoiled content is distributed. A spoiler is an additional component, which by addition degrades the content. Therefore, the spoiled content is less attractive. This is advantageous for content providers, because the spoiled content can be sold cheaper than unspoiled content, to make it more competitive to copied material. Further, one CD may be sold at two prices, a CD without spoilers for a higher price than a CD with spoilers. The spoiler also stays with the content if the content is compressed and distributed, e.g. as an MP3 file over Internet in the case the content is music. Users are in this way discouraged to copy the content, because the encoded signal is less attractive than the original signal. Depending on the embodiment, the spoiler can be removed from the signal at the price of more or less effort required by the user, which effort will discourage most users to remove the spoilers.

Advantageously, the spoiled content complies with a current format as well as with a further format, in which further format the spoilers are removable. Current players can only play degraded content (with spoilers), whereas new players according to the present invention comprise means to remove the spoiler and are thus able to provide a higher quality content that better corresponds to the original content. In this way, an incentive is provided for users to use a receiver according to this invention, which is an advantage for both manufactures and content providers. Preferably, the format is a generally industry format. In an embodiment of the invention, the content complies to an industry standard signal, e.g. a 16-bit PCM (Pulse Code Modulation) signal that is used for CD (Compact Disc).

Publishers, especially in the music industry look for ways to limit illegal distribution of content. This illegal distribution of content may e.g. happen in the form of copied CDs or in the form of MP3 files that were ripped of from a published disc. It is not commercially attractive to stop publishing in the current formats and change to new formats at once. The current invention provides the possibility to continue publishing on a current standard format, by providing a less attractive quality. The higher quality that is obtained by removing the additional signal components, so-called spoilers, can only be obtained in new players according to the present invention. The de-spoil information is only identifiable by a player according to the invention and may further be highly copy protected. Preferably, new players that can remove the spoilers are arranged to prevent copying of the unspoiled, higher quality content.

Advantageously, de-spoil information is provided, indicating how to remove the spoiler from the spoiled content. Providing this de-spoil information gives further business opportunities for the distributor. In an extreme embodiment of the invention, the de-spoil information has only one bit, which indicates if a predetermined spoiler is present in the signal or not.

In a further embodiment of the invention, the de-spoil information is provided in a protected form. This makes it harder to identify the de-spoil information and therefore to remove the spoilers. The de-spoil information may for example be concealed within said spoiled content, e.g. as buried data (see U.S. Pat. No. 5,649,054) or similar to the concealed control codes in above-mentioned U.S. Pat. No. 5,479,168. A further possibility is to encrypt the de-spoil information within the spoiled content. In the case that the de-spoil information is present in the signal, the de-spoil information can be copied. In a receiver according to the invention, a copy can then be de-spoiled.

Preferably, copies do not comprise sufficient information to de-spoil the spoiled content. This is provided in a further embodiment of the invention in which the de-spoil information is at least partly available on an additional channel, for example a physical mark on the disc or downloadable from the Internet. The same is true in the case of encrypted de-spoil information within the spoiled content, wherein at least part of the key is provided on an additional channel. In this case, not all the de-spoil information is copied, because the existing copying equipment cannot read the entire information. Therefore, in this embodiment, spoilers cannot be removed in copied content.

In an embodiment of the invention, the spoiler is concatenated to a part of the content, e.g. replacing part of the original content, whereas in alternative embodiments the spoiler is mixed with the content. In the case that the spoiler is mixed with the content, the spoiler and the content do not occur in separate time intervals, but mainly at the same time. An example of a mixed spoiler is noise, like an audible watermark. Messages like advertisements or jingles can be mixed and/or concatenated.

The invention can be applied for audio, video, photo's etc. The invention is especially advantageous in the case of CDDA (Compact Disc Digital Auido). The music industry can continue publishing on CDDA, which is a widely accepted format. CDs with spoilers may be offered at a reduced price, making a spoiled CD competitive with a copy on CD-R. De-spoil information may be offered at an additional fee, e.g. on the Internet, payable with a credit-card. CDs having features according to the present invention play on existing CD players, because the music does not deviate from the CDDA standard format. Further, an incentive exists to upgrade to CD2 players, which can remove the spoilers, and at the same time enforce copy protection rules much better than the existing CD players and recorders. In preferred embodiments, copied CDs contain the at least one spoiler, but not the de-spoil information anymore. This makes a copy inferior to an original disc.

The aforementioned and other aspects of the invention will be apparent from and elucidated with reference to the embodiments described hereinafter.

In the drawings:

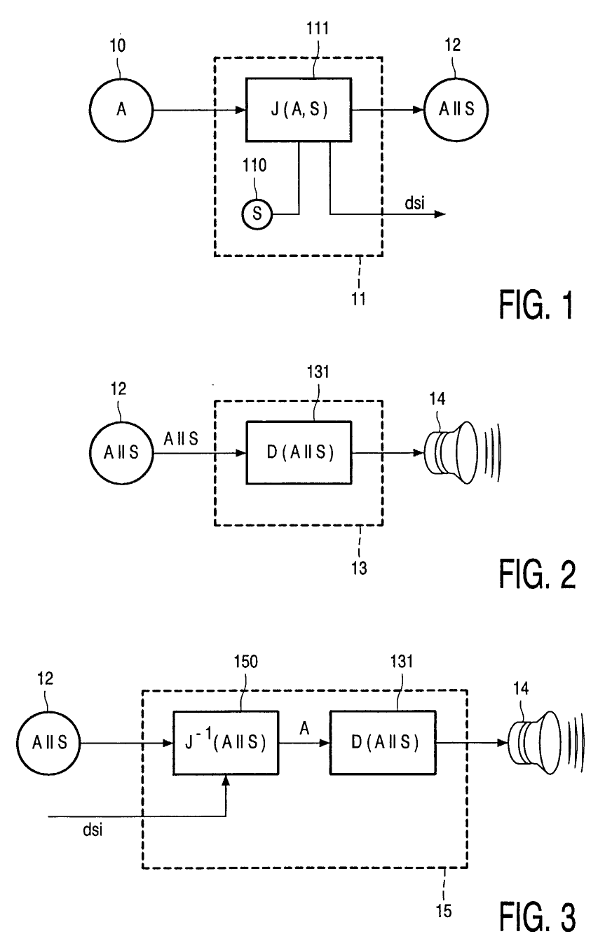

FIG. 1 shows distribution of content according to an embodiment of the invention;

FIG. 2 shows reproduction of spoiled content on a prior art receiver;

FIG. 3 shows reproduction of spoiled content on a receiver according to the invention;

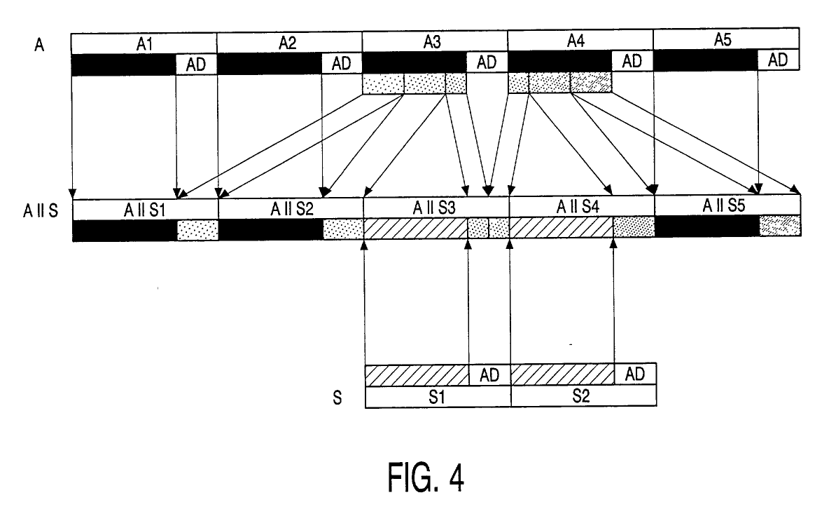

FIG. 4 shows a first example of how spoilers can be embedded in a signal according to an embodiment of the invention; and

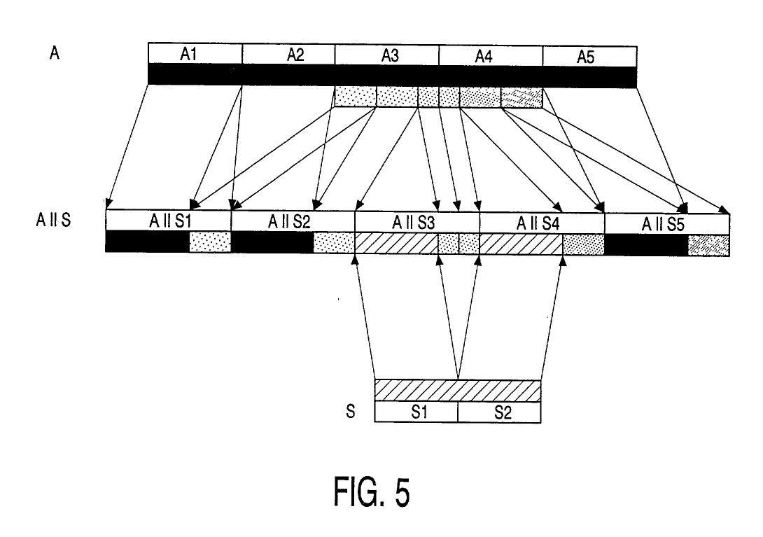

FIG. 5 shows a second example of how spoilers can be embedded in a signal according to an embodiment of the invention.

The drawings only show those elements that are necessary to understand the invention.

The following description is addressed to audio distribution, especially on CDDA (Compact Disc Digital Audio). It will be clear to a person skilled in the art that the same principles are applicable to other forms of content, e.g. video or photos or to other media.

FIG. 1 shows distribution of content according to an embodiment of the invention. Original content A, e.g. audio is provided at an input 10, e.g. a disc or antenna of a spoiler device 11. The original content A is usually coded, e.g. compressed, and may also include a watermark. A spoiler S is obtained from spoiler unit 110 and added to the content in adding means 111 to obtain a signal A∥S representing a spoiled signal. It will be clear to a person skilled in the art that the spoiler S is preferably be added in a suitable format, e.g. being subjected to a same compression mechanism than the content A in the case that the spoiler represents some message etc. The adding means 111 further provides de-spoil information dsi. The spoiled bit-stream A∥S is then distributed through a channel 12, e.g. CD-2. The de-spoil information dsi is transmitted using another channel, e.g. Internet download or the same channel 12, e.g. buried data, ancillary data.

FIG. 2 shows reproduction of spoiled content on a prior art receiver 13. The prior art receiver 13 is not able to remove the spoiler from the spoiled content A∥S. Still, the spoiled content complies with a format that can be handled by this receiver 13. Therefore, the prior art receiver 13 will reproduce the spoiled content A∥S on the output device 14 instead of the original content A. The receiver 13 comprises a digital to analog converter 131 to obtain an analog signal that can be reproduced on the output 14. In the case the output unit 14 is a digital output, the digital to analog converter 131 can be omitted. The output unit 14 may also provide both an analog and a digital output. Usually, the receiver 131 comprises some decoding means for decoding the content A. Such a decoder will allow pre-listen of scrambled audio plus spoilers.

FIG. 3 shows reproduction of spoiled content on a receiver 15 according to the invention. By using the proper decoder the spoilers S may be removed using de-spoil unit 150. The result of this operation is a de-spoiled signal similar to A, which is output to the output unit 14. In this embodiment, the output unit may also additionally or alternatively comprise a digital output, which provides preferably the spoiled signal A∥S.

The CDDA content is made less attractive by adding a spoiler to the signal. Such a spoiler is removable in the receiver 15 according to the present invention. In a further embodiment, information is added to the disc that can be used to remove the spoiler. Preferably, this de-spoil information (de-spoil in the sense that it indicates how to remove the spoiler(s)) is stored on the disc in protected form, such that existing CD players and CD-ROM players are unable to read the de-spoil information. Furthermore, the de-spoil information could be encrypted. The encryption key can be stored in the disc that can be understood only by special players, or alternatively not be stored on the disc, but provided via another channel, which may be the Internet, already present in the player. A special player being capable of removing the spoilers in the spoiled signal is called a CD2 player.

In a simple embodiment, the spoiler is a message, e.g. a jingle or a commercial message like an advertisement, added at an end of a track. The de-spoil information in this embodiment comprises a skip-list that tells the CD2 player which parts of the tracks to skip. This skip-list is preferably stored in encrypted form in a second data session on the CD. The key for decrypting the de-spoil information is also stored on the disc, but can only be read by a dedicated CD2 player, e.g. by storing this key in a key-locker, such as described in non-pre-published European patent application 00202888.4, filed Aug. 16, 2000 (our reference PHNL000448).

The spoiler stays with the music if the CD is copied using the existing methods for CD copying. In preferred embodiments, the de-spoil information (or the key) is not copied, because the existing copying equipment cannot read the de-spoil info. Hence, copied CDs cannot be de-spoiled. The spoiler also stays with the music if the music is compressed to e.g. MP3 and distributed over the Internet.

A few examples of spoilers are given below:

Advertisements between the tracks (removal with skip-list)

Someone announcing and explaining the music between the tracks, like a radio station (removal with skip-list)

Advertisements (or someone talking) during the music in the tracks; removal may be done by subtracting a bit-stream that contains the spoiler

Sound quality reduction (restoration is done with information that is stored in a separate bit-stream, which can e.g. be hidden in the PCM stream by using the buried data technique)

The key that unlocks the de-spoiler information:

can be downloadable from the Internet and be stored inside the CD2 player

can be downloadable from the Internet and stored on the disc, if the disc has the capability to record information

a key can be provided that can only be used with a given player or disc, which should therefore have a unique identifier

can be stored on the published disc in a way that can only be read by a CD2 player

FIG. 4 shows how audio spoiler frames S1, S2 and audio frames A1 . . . A5 could be concatenated to a spoiled audio bit-stream A∥S. Here, the original audio bit-stream A and the audible spoilers S1, S2 are compressed at the same bit-rate and with empty ancillary data fields A0. After this, the spoiler payload S1, S2 replaces the original audio payload A3, A4 and the original audio payload A3, A4 at spoiler location is embedded into the bit-stream A∥S as ancillary data.

FIG. 5 shows an alternative audible spoiler embedder. Here, ancillary data is created only in the resulting bit-stream. Intermediate bit-streams are independent of the to be embedded audible spoiler, though some extra bit-stream manipulation may be necessary.

The invention is advantageously applied in digital audio players, CD-DA, CD-2, Internet music distribution.

Embodiments of the present invention may also be combined with non pre-published European patent application 99202633.6, filed Aug. 13, 1999 (our reference PHN17.589), which describes transmitting of an M-bit PCM signal, wherein a signal remains compatible with industry standardized signal playback apparatuses not incorporating the features of PHN17.589 but has a higher quality on apparatuses incorporating features of PHN17.589. In combination with the present invention, this would lead to a spoiled signal, wherein after removal of the spoilers a signal results having a higher quality than a standard M bit PCM signal.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

In summary, distributing content is provided, wherein at least one spoiler is added to the content to obtain spoiled content, and the spoiled content is distributed. In an embodiment, the spoiled content complies with a current industry format as well as with a further industry format, in which further industry format the spoilers are removable. In a further embodiment, de-spoil information is provided indicating how to remove the spoiler from the spoiled content.

1. A method of distributing content, the method comprising the steps of:
adding at least one spoiler to the content to obtain spoiled content, and
distributing the spoiled content.

2. A method as claimed in claim 1, wherein the spoiled content complies with a current format as well as with a further format, in which further format the spoilers are removable.

3. A method as claimed in claim 1 or 2, the method further comprising:
providing de-spoil information indicating how to remove the spoiler from the spoiled content.

4. A method as claimed in claim 3, wherein the de-spoil information is at least partly provided in a protected form.

5. A method as claimed in claim 4, wherein the de-spoil information is at least partly concealed within said spoiled content.

6. A method as claimed in claim 4, wherein the de-spoil information is at least partly encrypted within said spoiled content.

7. A method as claimed in claim 3, wherein the de-spoil information provides address information indicating where to get additional de-spoil information.

8. A method as claimed in claim 4, wherein the de-spoil info is at least partly provided on an additional channel.

9. A method as claimed in claim 1 or 2, wherein the spoiler is concatenated at an end of a given part of the content.

10. A method as claimed in claim 9, wherein the de-spoil information comprises an edit or skip list indicating a position of the spoiler.

11. A method as claimed in claim 3, wherein parts of the content are replaced by spoilers, and wherein the de-spoil information further indicates how the replaced content parts can be obtained to replace the spoilers in the spoiled content.

12. A method as claimed in claim 1 or 2, wherein the step of adding comprises mixing the original content with the at least one spoiler to obtain the spoiled content.

13. A method as claimed in claim 12, wherein the spoiler is noise.

14. A method as claimed in claim 9 or 12, wherein the spoiler is a message.

15. A method of receiving spoiled content, the method comprising the step of:
identifying at least one spoiler in the spoiled content, and
removing the at least one spoiler from the spoiled content to obtain a de-spoiled signal.

16. A method as claimed in claim 15, the method further comprising the step of:
identifying de-spoil information, and
using the de-spoil information in the removing step.

17. A signal representing content, in which signal at least one spoiler has been added to the content.

18. A signal representing de-spoil information, which de-spoil information indicates how to remove a spoiler from spoiled content.

19. A signal representing a key, which key indicates how locked de-spoil information can be unlocked.

20. A tangible medium on which a signal as claimed in claim 17, 18 or 19 has been stored.

21. A tangible medium comprising a first data part and a second data part, on which a first signal representing content has been stored on the first data part, in which first signal at least one spoiler has been added to the content, and on which medium a second signal representing de-spoil information has been stored on the second data part, the de-spoil information indicating how to remove a spoiler from spoiled content.

22. A device for distributing content, the device comprising:
means for adding at least one spoiler to the content to obtain spoiled content, and
means for distributing the spoiled content.

23. A device for receiving spoiled content, the device comprising:
means for identifying at least one spoiler in the spoiled content, and
means for removing the at least one spoiler from the spoiled content to obtain a de-spoiled signal.

24. A reproduction device comprising a receiver as claimed in claim 23 and an output unit for outputting a representation of the de-spoiled signal.

25. Computer program for enabling a processor to carry out the method according to claim 15.

26. Signal carrying a computer program according to claim 25.

27. Tangible medium carrying a computer program according to claim 25.
